(19) United States
(12) Patent Application Publication
(10) Pub. No.: US 2005/0090939 A1
(43) Pub. Date: Apr. 28, 2005

(54) VISION BASED WIRELESS COMMUNICATION SYSTEM

(76) Inventors: Aaron L. Mills, Ann Arbor, MI (US); Frank A. MacKenzie, Dearborn, MI (US); Gerald H. Engelman, Plymouth, MI (US); Liwen Xu, Southfield, MI (US); Michael J. Richardson, Worcestershire (GB); Samir Mohamad Beydoun, Dearborn Heights, MI (US)

Correspondence Address: KEVIN G. MIERZWA;ARTZ & ARTZ, P.C., 28333 TELEGRAPH ROAD, SUITE 250, SOUTHFIELD, MI, 48034, US

(21) Appl. No.: 10/605,788

(22) Filed: Oct. 27, 2003

(51) Int. Cl. G06F 17/00

(52) U.S. Cl. 701/1; 348/148

(57) ABSTRACT

A wireless vehicle communication update system (10) for a vehicle (12) includes a vision sensor (14) that is coupled to a vehicle body (16) of the vehicle (12). The vision sensor (14) wirelessly detects a vehicle information signal from an off-board vehicle setting update device (20) that contains setting information for the vehicle (12). A vehicle controller (18) updates at least one vehicle setting in response to the vehicle information signal.

### BACKGROUND OF INVENTION

The present invention relates generally to wireless communication systems. More particularly, the present invention relates to a method and system for wireless communication of vehicle setting and configuration related information.

Currently, vehicle setting and configuration related information is communicated between a main vehicle onboard controller and an off-board computer. For example, when a technician is performing a diagnostic test or is simply gathering vehicle information the technician connects the vehicle controller to a diagnostic testing computer via an on-board diagnostics (OBD) connector and appropriate cabling therebetween.

It is efficient to use the diagnostic computer and the OBD for rapidly transmitting and receiving secured vehicle information. This is especially true when the vehicle is undergoing repairs or during end-of-line final testing. However, the diagnostic controller, the OBD, and the corresponding wiring are costly and can be limited in use. Specialized equipment, such as the diagnostic controller can be complex and require specialized training to utilize. Thus, only an individual with such training can perform an information transfer to the vehicle controller. Also, the location where an information transfer can be performed is limited due to the physical wired connection between the diagnostic controller and the vehicle controller.

In addition, during production of a vehicle, vehicle settings and configurations are enabled to satisfy customer preferences and other vehicle requirements. To enable the settings and configurations a physical wired connection, such as mentioned above, is typically created between the vehicle controller and an off-board computer, which can be time consuming. The wired connections, during production, can interfere with other production tasks resulting in the connection being bothersome.

As well, it is often desirable to perform a vehicle software update or preference modification to a vehicle. In order to perform such updates and modifications the vehicle must be transported to a dealer or service station that has the appropriate diagnostic or off-board controller, which is capable of performing the desired updates and modifications.

Thus, there exists a need for a vehicle communication system that allows for setting and configuration related information to be easily updated and that minimizes equipment and training costs involved therein.

### SUMMARY OF INVENTION

The present invention provides a method and system for wirelessly communicating vehicle update information to a vehicle. The system includes a vision sensor that is coupled to a vehicle body of the vehicle. The vision sensor wirelessly detects a vehicle information signal from an off-board vehicle setting update device that contains setting information for the vehicle. A vehicle controller updates at least one vehicle setting in response to the vehicle information signal.

One of several advantages of the present invention is that it provides a simple technique for updating vehicle settings without use of specialized equipment and without use of an on-board diagnostic connector. In so doing, the present invention provides an inexpensive wireless system for updating vehicle settings that may be utilized by vehicle manufacturers, vehicle dealers, service stations, and customers or vehicle owners.

Another advantage of the present invention is that it provides a wireless system for updating vehicle settings that is capable of sharing componentry with other vision-based vehicle safety systems, thereby, further decreasing number of system components, system complexity, and system costs.

Furthermore, the present invention is versatile in that it provides multiple techniques that may be applied in updating vehicle settings depending upon the application.

The present invention itself, together with attendant advantages, will be best understood by reference to the following detailed description, taken in conjunction with the accompanying figures.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a block diagrammatic view of a wireless vehicle communication update system for a vehicle in accordance with an embodiment of the present invention.

FIG. 2 is a block diagrammatic view of an off-board vehicle update system in accordance with an embodiment of the present invention.

FIG. 3 is a perspective and block diagrammatic view of a vehicle assembly line utilizing the update system in accordance with another embodiment of the present invention.

FIG. 4 a logic flow diagram illustrating a method of wirelessly communicating vehicle updates utilizing the update system of FIG. 1 in accordance with an embodiment of the present invention; and.

FIG. 5 is a logic flow diagram illustrating a method of wirelessly communicating vehicle updates utilizing the update system of FIG. 1 and multiple status indication signals in accordance with another embodiment of the present invention.

### DETAILED DESCRIPTION

While the present invention is described with respect to a method and system for wirelessly updating vehicle settings for a vehicle, the present invention may be adapted to be used in various applications and systems including:
vehicle setting and configuration adjusting systems, collision warning systems, collision avoidance systems, vehicle systems, or other systems known in the art. The present invention may be applied not only to land vehicles, but also to non-land vehicles.

In the following description, various operating parameters and components are described for one constructed embodiment. These specific parameters and components are included as examples and are not meant to be limiting.

Also, in the following description the term “performing” may include activating, deploying, initiating, powering, and other terms known in the art that may describe the manner in which a countermeasure may be operated.

Additionally, in the following description the term “countermeasure” may refer to an object or may be refer to an action. For example, a countermeasure may be performed or a countermeasure may be activated. An airbag is a countermeasure. A controller may perform a countermeasure by signaling the airbag to deploy.

Moreover, a countermeasure device may be any device within an automotive vehicle that is used in conjunction with a collision countermeasure system including: a controller, a vehicle system, an indicator, or other countermeasure device known in the art.

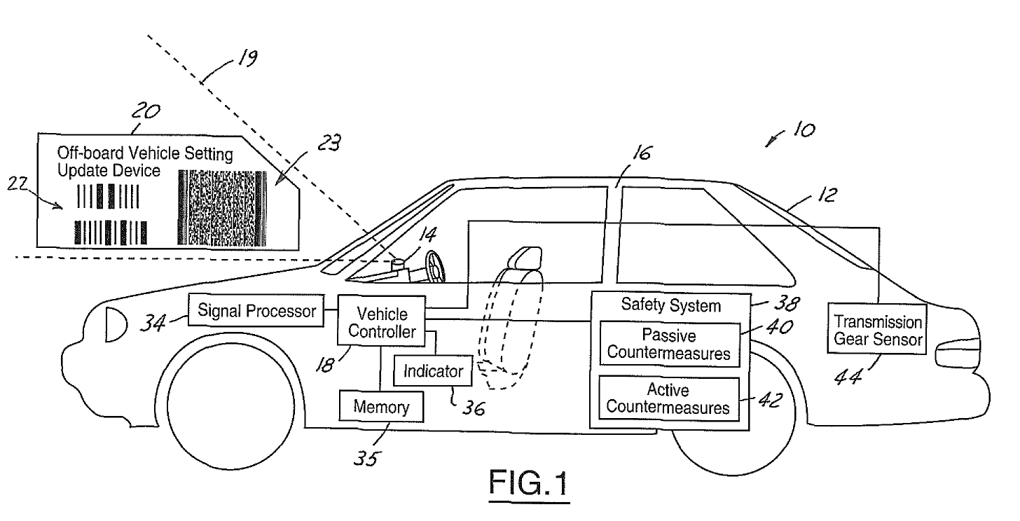

Referring now to FIG. 1, a block diagrammatic view of a wireless vehicle communication update system 10 for a vehicle 12 in accordance with an embodiment of the present invention is shown. The update system 10 includes a vision sensor 14, which is coupled to a vehicle body 16 of the vehicle 12, and a vehicle controller 18. The vision sensor 14 wirelessly detects an information signal, within a reception range 19, from an off-board vehicle setting update device 20. The off-board update device 20 contains setting information for the vehicle 12. The vehicle controller 18 updates vehicle settings in response to the information signal.

A vehicle setting may refer to a memory setting, a switch state, a variable setting, or some other type of vehicle setting known in the art. A vehicle setting may be a customer comfort and convenience setting, a vehicle performance setting, a vehicle safety system setting, a software setting, a communication setting, a diagnostic setting, a system configuration, a video or audio setting, a dealer option setting, a factory option setting, or other setting known in the art.

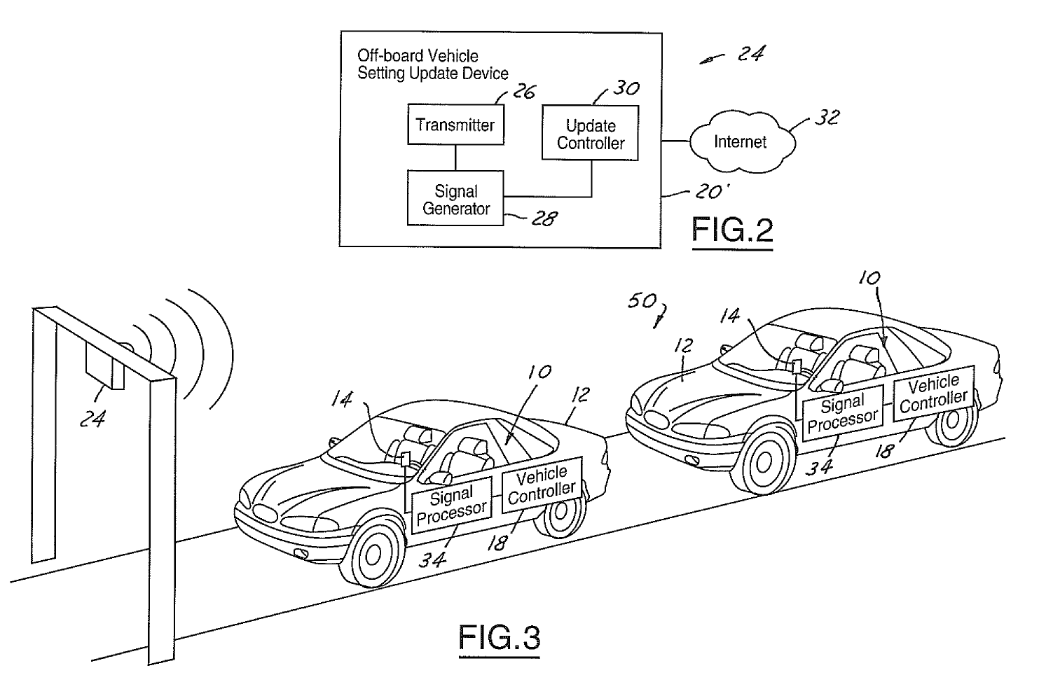

The vision sensor 14 may be a camera, a charged-coupled device, a bar code reader, an infrared detector, a photodiode, or other vision sensor known in the art. The vision sensor 14 in one embodiment of the present invention is utilized to scan or read various bar codes 22, as shown. The bar codes 22 have desired vehicle setting information for the vehicle 12. In another embodiment of the present invention the vision sensor 14 is utilized to detect a pulse-coded light signal also containing vehicle setting information, as is described with respect to the embodiments of FIGS. 2 and 3. The vision sensor 14 may be of various type and style known in the art. The vision sensor 14 may be located in various locations on the vehicle 12.

The vehicle controller 18 may be microprocessor based such as a computer having a central processing unit, memory (RAM and/or ROM), and associated input and output buses. The controller 18 may be an application-specific integrated circuit or may be formed of other logic devices known in the art. The controller 18 may be a portion of a central vehicle main control unit, an interactive vehicle dynamics module, a restraints control module, a main safety controller, or may be a stand-alone controller as shown.

Referring also to FIG. 2, the off-board update device 20 may be passive or active. The update device 20 may be in the form of an encoded image, such as the one-dimensional bar codes 22 or the two-dimensional bar code 23. The update device 20 may be in the form of an off-board updating system 24. The bar codes 22 and 23 may be formed to contain an encrypted or coded signal corresponding to the vehicle 12 and the settings to be updated.

The off-board updating system 24 may include a transmitter 26, a signal generator 28, and an update controller 30. The transmitter 26 transmits an information signal to the vision sensor 14. The transmitter 26 may be in the form of a light source, such as an incandescent light or an infrared light. The transmitter 26 may also be in the form of an encoded image printed to paper or equivalent. The transmitter 26 may also be in the form of a series of light emitting diodes (LEDs) or in some other form known in the art. The update controller 30 determines the vehicle settings to update and generates a pulse-coded signal, containing update information for the vehicle settings to be updated, via the signal generator 28.

The update controller 30 may receive setting information via an Internet 32, an Intranet (not shown), an internal network (not shown), or via some other method known in the art. The update controller 30 may also be microprocessor based such as a computer having a central processing unit, memory, and associated input and output buses or be formed of various logic devices, similar to vehicle controller 18.

Referring again to FIG. 1, a signal or image processor 34 is coupled between the vision sensor 14 and the vehicle controller 18. The signal processor 34 receives and converts the information signal, generated by the vision sensor 14, into a proper format for reception by the controller 18. The signal processor 34 may include analog-to-digital converters, filters, amplifiers, as well as other signal conditioning components known in the art. The signal processor 34 may be part of the vision sensor 14, may be part of the vehicle controller 18, may be a stand-alone device, as shown, or may be some combination thereof.

An external memory 35 may be coupled to the vehicle controller 18. The external memory 35 stores vehicle setting related information. The vehicle controller 18 may access the memory 35 when updating the vehicle settings.

An indicator 36 may be coupled to the vehicle controller 18 and indicate current vehicle setting related information as well as safety system related information. The indicator 36 may also indicate when an information signal has been received and whether it has been properly received. The indicator 36 may include a video system, an audio system, a horn, an LED, a light, a global positioning system, a heads-up display, a headlight, a taillight, a display system, a telematic system, or other visual or audible indicator known in the art. The indicator 36 may indicate warning signals, countermeasure signals, or other signals known in the art.

A safety system 38 may be coupled to the vehicle controller 18 and include object detection sensors, such as the vision sensor 14, and the signal processor 34. The safety system 38 may include passive countermeasures 40 and active countermeasures 42 as well as other safety system components, systems, or controllers known in the art.

The passive countermeasures 40 may include internal air bag control, seatbelt control, knee bolster control, head restraint control, load limiting pedal control, load limiting steering control, pretensioner control, external air bag control, pedestrian protection control, and other passive countermeasures known in the art.

The active countermeasures 42 may include brake control, throttle control, steering control, suspension control, transmission control, and other vehicle control systems. The vehicle controller 18 may signal the indicator 36 of an impending potential collision so that a vehicle operator may actively perform a precautionary action.

A transmission gear sensor 44 may be coupled to the vehicle controller 18 and detect transmission gear status. The transmission gear sensor 44 determines a current gear setting of a transmission (not shown) of the vehicle 12 and generates a transmission gear signal.

Referring now to FIG. 3, a perspective and block diagrammatic view of a vehicle assembly line 50 utilizing the update system 10 in accordance with another embodiment of the present invention is shown. The update system 10 may be utilized during production of the vehicle 12. The update system 10 may be used to set or configure the vehicle 12 according to standard and selected options associated therewith. By using the update system 10 as opposed to a diagnostic computer and on-board diagnostics (OBD) connector, no physical connection need be performed in order to transfer the setting information. Since a wired connection need not be performed, as in prior art systems, assembly labor time and costs are reduced.

Also, the update system 10 minimizes interference with other assembly tasks by wirelessly receiving the update setting information. For example, the off-board update device 20 or the off-board update system 24 may be located overhead and provide setting information to the update system 10 as the vehicle 12 passes under the off-board update system 24, as shown. Of course, the off-board update system 24 may be located in various other locations.

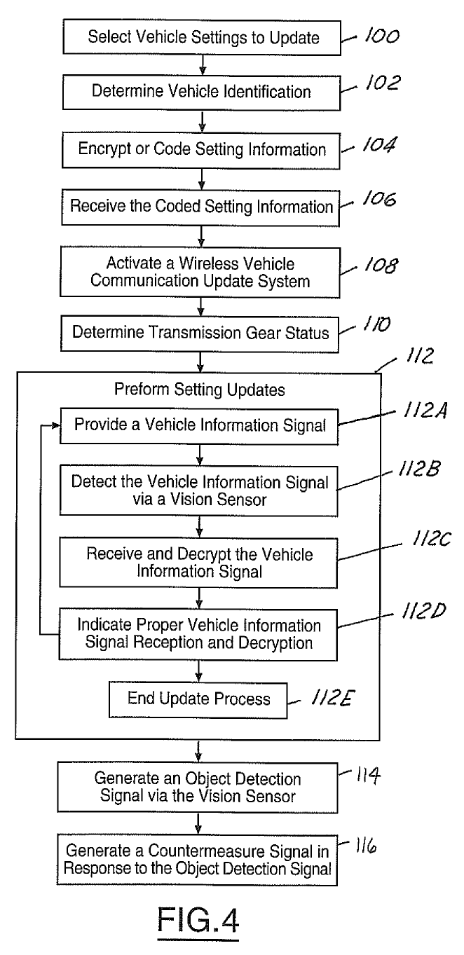

Referring now to FIG. 4, a logic flow diagram illustrating a method of wirelessly communicating vehicle updates utilizing the update system 10 in accordance with an embodiment of the present invention is shown.

In step 100, vehicle settings to update are selected. The vehicle settings may be selected by a vehicle manufacturer, a vehicle dealer, by an end user, or the like. The vehicle manufacturer may, for example, select settings to be updated and develop software updates corresponding to each setting. A customer on the other hand may access an Internet site or a website and select vehicle settings to be updated, in effect personalizing the vehicle settings. In response to the selected vehicle settings the manufacturer or dealer may then provide the off-board update device 20 to the customer to perform an update on the vehicle settings. As stated above, the off-board update device 20 may be in the form of a series of bar codes, such as bar codes 22.

In step 102, a determination is made as to the vehicle being updated. The vehicle manufacturer, the dealer, or the customer may determine a vehicle identification number, a model number, a production year, etc. of the vehicle 12. Step 102 may be performed before or simultaneously with step 100, such that the settings may be developed in response to the vehicle identification.

In step 104, the vehicle manufacturer or dealer encrypts or codes the setting information into a format for reception by the update system 10. The setting information may be uploaded to or accessible via an Internet site. The off-board update system 24 or the customer may than access the site to receive the coded setting information.

In step 106, the off-board update system 24 or the customer receives the coded setting information. The vehicle manufacturer or dealer may convert the coded setting information into an information signal. The information signal may be in the form of a series of bar codes, such as bar codes 22. The bar codes 22 may than be printed out and utilized by the customer to update the system 10.

In step 108, the update system 10 is activated. The update system 10 may be activated by an ignition lock assembly (not shown) when the vehicle accessories are activated or when the vehicle ignition is enabled. The update system 10 may also be activated by an associated enabling device, by some other method known in the art, or by some combination thereof. An associated enabling device may, for example, be a switch that is associated with and specifically enables the update system 10.

In step 110, the vehicle controller 18 determines transmission gear status in response to the transmission gear signal. When the vehicle 12 is in a drive or reverse gear the vehicle controller 18 may cease to update the vehicle settings.

In step 112, setting updates are performed. When the vehicle 12 is not in a drive or reverse gear the vehicle controller 18 allows setting updates to be performed.

In step 112A, an information signal is generated or provided for reception by the vision sensor 14. When the off-board update system 24 is utilized it may generate an information signal in response to the coded setting information. The setting information may be pre-coded by the vehicle manufacturer or the dealer or may be coded by the update controller 30. The off-board updating system 24 may generate the information signal in the form of a pulsed light signal and transmit the light signal in viewing range of the vision sensor 14. When the bar codes 22 are utilized they may be held in front of the vision sensor 14 within the reception range 19.

In step 112B, the vision sensor 14 detects an information signal from the off-board vehicle setting update device 20.

In step 112C, the signal processor 34 receives and decrypts the vehicle information signal.

In step 112D, the controller 18 may indicate via the indicator 36 when the information signal is received and decrypted appropriately. For example, when the information signal has been received appropriately, a vehicle horn may be honked. In another example, the indicator 36 may be in the form of a display visually indicating the vehicle setting information being updated.

In step 112E, when the vehicle information signal is received and decrypted appropriately the vehicle controller 18 returns to step 112A, otherwise the vehicle controller 18 ends the above-described update process. When each information signal has been received and the vehicle 12 has been updated accordingly the vehicle controller 18 also ends the update process.

The vehicle controller 18 throughout any of the above steps may indicate any vehicle setting on the indicator 36.

In step 114, the safety system 38 detects an object via the vision sensor 14 and generates an object detection signal.

In step 116, the vehicle controller 18 generates a safety system signal in response to the object detection signal. The vehicle controller 18 may then perform a countermeasure in response to the safety system signal.

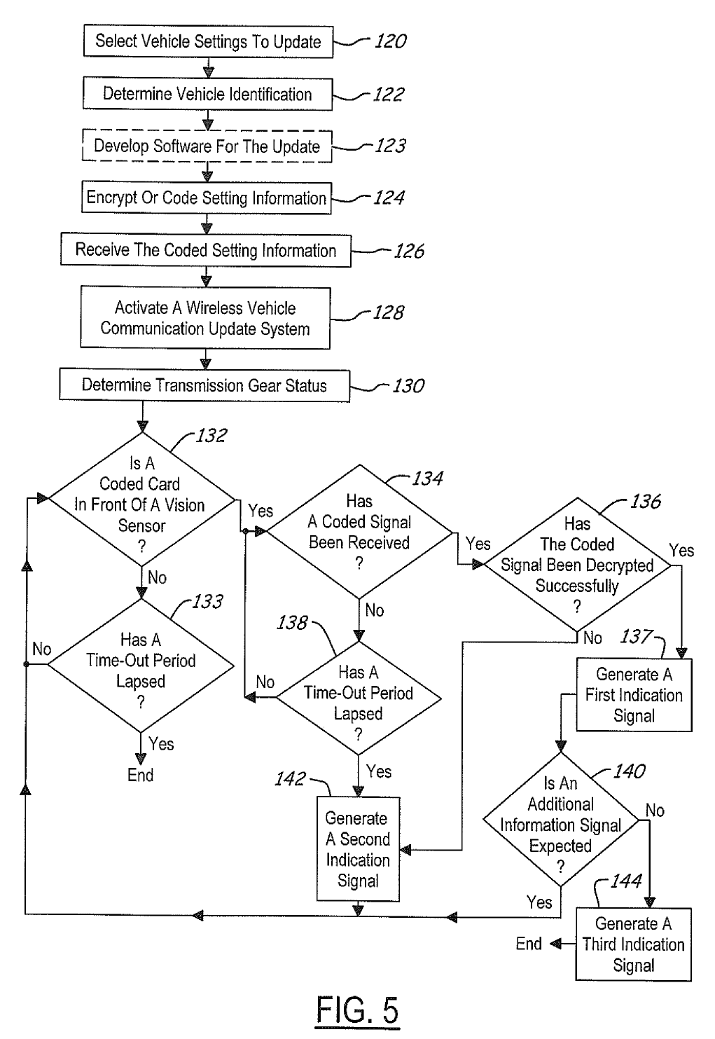

Referring now to FIG. 5 a logic flow diagram illustrating an example method of wirelessly communicating vehicle updates utilizing the update system of FIG. 1 in accordance with another embodiment of the present invention is shown.

Steps 120-130 are similar to steps 100-110 above. In step 120, vehicle settings to update are selected. The vehicle settings may be selected by a vehicle manufacturer, a vehicle dealer, by an end user, or the like. In step 122, a determination is made as to the vehicle being updated. In step 123, a vehicle manufacturer or dealer may develop software for the update to be performed. In step 124, the vehicle manufacturer or dealer encrypts or codes the setting information into a format for reception by the update system 10.

In step 126, the off-board update system 24 or the customer receives the coded setting information. The coded setting information may be mailed to the customer in the form of coded cards or the customer may receive the coded setting information in such a format as to allow the customer to print out the coded information.

In step 128, the update system 10 is activated. In step 130, the vehicle controller 18 determines transmission gear status in response to the transmission gear signal. When the vehicle 12 is in a drive or reverse gear the vehicle controller 18 ceases to update the vehicle settings, otherwise the controller 18 proceeds to step 132.

In step 132, the customer places a coded card in front of the vision sensor 14. When a coded card is in front of the vision sensor 14 the controller 18 proceeds to step 134, otherwise the controller 18 activates a time-out procedure, which is designated by box 133. When a predetermined amount of time has lapsed and the vision sensor 14 has not detected a recognizable coded card the controller 18 ends the update process.

In step 134, when the controller 18 has received an information signal from the recognized coded card the controller 18 proceeds to step 136, otherwise the controller 18 again activates a time-out procedure, which is designated by box 138.

In step 136, when the controller 18 has decrypted the information signal successfully the controller 18 generates a first indication signal, which may be indicated via the indicator 36, as is designated by box 137. In one embodiment of the present invention, the first indication signal is in the form of a signal honk. The controller 18 then proceeds to step 140. When the controller 18 does not decrypt the information signal successfully a second indication signal is generated, designated by box 142. For example, the second indication signal may be in the form of a pair of honks. Following generation of the second indication signal the controller 18 returns to step 132.

In step 140, the controller 18 determines whether an additional information signal is expected. When another information signal is expected the controller 18 returns to step 132, otherwise the controller 18 generates a third indication signal, designated by box 144. The third indication signal signifies that the update procedure is completed. The third indication signal may be in the form of three honks.

The above-described steps in FIGS. 4 and 5 are meant to be illustrative examples; the steps may be performed sequentially, synchronously, simultaneously, or in a different order depending upon the application. Various time-outs may be incorporated into the above-described process. For example, when any of the above steps are being performed for a time period that is greater than a predetermined time period the vehicle controller 18 may end or reset the updating process or reperform a current step being performed.

The present invention provides a wireless vehicle communication update system that facilitates updating vehicle setting information. The present invention allows setting information to be updated without specialized equipment and a physical wired connection. The present invention allows a vehicle customer to modify, update, and personalize vehicle setting information as desired without transport of the vehicle to a dealer or service station.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A wireless vehicle communication update system for a vehicle comprising:
a vision sensor coupling a vehicle body of the vehicle and wirelessly detecting a vehicle information signal from an off-board vehicle setting update device having setting information for the vehicle; and
a vehicle controller updating at least one vehicle setting in response to said vehicle information signal.

2. A system as in claim 1 wherein said vision sensor comprises at least one vision sensor selected from a camera, a charged-coupled device, a bar code reader, an infrared detector, and a photodiode.

3. A system as in claim 1 wherein said vision sensor detects said vehicle information signal from a passive off-board vehicle setting update device.

4. A system as in claim 1 wherein said vision sensor detects said information signal from an active off-board vehicle setting update device.

5. A system as in claim 1 wherein said vision sensor in detecting said vehicle information signal detects at least one bar code.

6. A system as in claim 1 wherein said vision sensor detects said vehicle information signal from an off-board vehicle setting update system.

7. A system as in claim 6 wherein said off-board vehicle setting update system comprises:
a transmitter transmitting said vehicle information signal in response to a pulse-coded signal;
a signal generator generating said pulse-coded signal; and
an update controller determining said at least one vehicle setting to update and causing generation and transmission of said pulse-coded signal and said vehicle information signal in response to said at least one vehicle setting.

8. A system as in claim 1 further comprising a signal processor receiving and formatting said vehicle information signal for said vehicle controller, said vehicle controller updating said at least one vehicle setting in response to said formatted vehicle information signal.

9. A system as in claim 1 wherein said controller in updating said at least one setting comprises adjusting at least one setting selected from a memory setting, a switch state, and a variable setting.

10. A system as in claim 1 wherein said controller in updating said at least one setting updates a setting selected from at least one of a comfort and convenience setting, a vehicle performance setting, a vehicle safety system setting, a software setting, a communication setting, a diagnostic setting, a system configuration, a video setting, an audio setting, a dealer option setting, and a factory option setting.

11. A system as in claim 1 further comprising an indicator coupled to said vehicle controller and indicating at least one current vehicle setting.

12. A system as in claim further comprising an indicator coupled to said vehicle controller and indicating when said vehicle information signal is received.

13. A method of wirelessly communicating vehicle updates to a vehicle comprising:
detecting a vehicle information signal from an off-board vehicle setting update device containing setting information for the vehicle; and
updating at least one vehicle setting in response to said vehicle information signal.

14. A method as in claim 13 further comprising:
determining said at least one vehicle setting to update;
determining vehicle identification;
generating a coded signal in response said at least one vehicle setting and said vehicle identification; and
updating said at least one vehicle setting in response to said coded signal.

15. A method as in claim 13 further comprising:
determining said at least one vehicle setting to update;
determining vehicle identification;
generating a coded signal in response said at least one vehicle setting and said vehicle identification; and
updating an Internet site to contain an access to said coded signal.

16. A method as in claim 13 wherein updating said at least one vehicle setting is performed in response to at least one bar code.

17. A method as in claim 13 wherein updating said at least one vehicle setting is performed in response to at least one pulsed light signal.

18. A method as in claim 13 wherein updating at least one vehicle setting is ceased when the vehicle is in a drive or reverse gear.

19. A vehicle comprising:
a vision sensor wirelessly detecting a vehicle information signal from an off-board vehicle setting update device containing setting information for the vehicle and detecting an object and generating an object detection signal; and
a vehicle controller updating at least one vehicle setting in response to said vehicle information signal and generating a safety system signal in response to said object detection signal.

20. A vehicle as in claim 19 further comprising at least one countermeasure, said vehicle controller enabling said at least one countermeasure in response to said safety system signal.
